(19) United States
(12) Patent Application Publication
(10) Pub. No.: US 2003/0171482 A1
(43) Pub. Date: Sep. 11, 2003

(54) Thermoplastic coating material for wood surfaces and in particular for wood-encased pencils

(75) Inventors: Udo Beck, Nurnberg (DE); Reiner Appel, Oberasbach (DE)

Correspondence Address: VENABLE, BAETJER, HOWARD AND CIVILETTI, LLP, P.O. BOX 34385, WASHINGTON, DC, 20043-9998, US

(73) Assignee: Faber-Castell AG, Stein (DE)

(21) Appl. No.: 10/383,590

(22) Filed: Mar. 10, 2003

(30) Foreign Application Priority Data
Mar. 8, 2002 (DE) 102 10 375.5

(51) Int. Cl. C08L 29/04

(52) U.S. Cl. 524/503; 524/502

(57) ABSTRACT

A material for coating a wood surface includes a thermoplastic coating material comprising a polyvinyl butyral polymer.

### CROSS-REFERENCE TO RELATED APPLICATION

This application claims the priority of German Patent Application No. 102 10 375.5 filed Mar. 8, 2002, the disclosure of which is incorporated herein by reference.

### BACKGROUND OF THE INVENTION

The invention relates to a thermoplastic coating material for wood surfaces and, in particular, for wood-encased pencils.

The coating or enameling of wood-encased lead pencils, colored pencils or cosmetic pencils protects the pencil and serves a decorative purpose. Traditionally, it has been realized by using enamels on a solvent base or watery binding-agent dispersions. The first have the disadvantage that solvents evaporate during the drying process, which poses a considerable health risk to the personnel handling the product. As a result, a high technical expenditure is required to filter these solvents out of the environmental air. To be sure, enamel coatings on the basis of watery polymer dispersions are friendlier to the environment, but have the disadvantage that they must be dried relatively slowly or at higher temperatures, thus requiring an increased amount of energy or time.

Enamels on a water basis or solvent basis furthermore have the disadvantage that for the enameling of wood-encased pencils, up to ten successive enameling runs are required to obtain high-quality and visually faultless coatings. Among other things, this results from the fact that these enamels contain in part more than 50% volatile components (solvent or water) which consequently do not contribute to the layer buildup on the wood surface.

These types of problems do not arise when using thermoplastic coating materials. A method for coating wood pencils with a hot-melting polyester is known from German Patent No. 30 36 451. However, this coating has the disadvantage of not being glossy and must therefore be coated with traditional solvent-based enamel. In addition, polyester does not have the scratch resistance that is necessary for pencil surfaces.

A synthetic material cover layer for pencils and leads, using either polyethylene or PVC, is disclosed in Unexamined Published German Patent Application 197 54 083 A1.

A coating material on the basis of thermoplastic polyamide resins is described in Unexamined Published German Patent Application 100 03 792 A1. The admixture of maleic anhydride is proposed for improving the adherence of the polyamide to the wood.

### SUMMARY OF THE INVENTION

It is an object of the present invention to suggest an alternative thermoplastic coating material for wood surfaces, particularly for wood-encased pencils.

The above and other objects are achieved according to the invention by the provision of a material for coating a wood surface, comprising: a thermoplastic coating material including a polyvinyl butyral polymer. According to an exemplary embodiment of the invention, the coating material is composed of a polyvinyl butyral polymer as a main constituent.

In contrast to the coatings deposited in the form dispersions or solutions, using a coating material composed exclusively of polyvinyl butyral polymer (in the following called PVB) results in a thermoplastic film being deposited during a single depositing operation on the wood and/or pencil surface. This coating fills pores or uneven spots in the wood despite being very thin and results in a smooth and high-quality surface. In addition to wood surfaces, experiments have shown that the material is also suitable for coating so-called derived timber products. As a rule, these are composed of one or several polymers and organic fibers such as wood dust or cellulose fibers as filler materials. In the case of wood-encased pencils, the coating materials according to the invention can be sharpened by cutting off shavings and result in scratch-resistant surfaces that can be printed on. They can be applied in a single operation in the form of so-called rapid-hardening melts by using the submerging process or, in the case of wood-encased pencils, the so-called push-through method. No health-endangering or caustic substances are released in the process. PVB can be mixed with a plurality of different substances, thus making it possible to vary the characteristics of a coating produced with this material over a wide range. Thus, one exemplary variant contains an adhesion promoter for adjusting the adhesion of the coating to different types of surfaces. Adhesion promoters in the form of oils on the basis of polyacrylates, polyurethanes, polyvinyl acetates, keto aldehyde resins, sucrose derivatives and polyester resins have proven particularly suitable. The use of a hot-melt is also conceivable.

### DETAILED DESCRIPTION OF THE INVENTION

One exemplary basic formulation provides for 40 to 100 weight % PVB, 0 to 60 weight % adhesion promoter, 0 to 10 weight % coloring agent, 0 to 50 weight % filler materials and 0 to 20 weight % of additives. Surprisingly, it has turned out that the otherwise mostly mat surface of the coating will become particularly glossy through the admixture of wax. Wax in this connection is understood to include all vegetable, animal and mineral waxes, fatty acid derivatives, polyolefin waxes, oxidized polyethylene waxes, montan waxes and the like. Particularly suitable is hydrated castor oil. The filler materials used are inorganic and organic substances such as kaolin, talcum, chalk, barium sulfate, cellulose fibers and polyolefin. Adding plasticizing (softening) agents can specifically influence the flexibility and brittleness of the coating. Plasticizers on the basis of adipic acid or other organic acids, as well as their polyesters, are particularly suitable.

All known organic or inorganic pigments can be used as coloring agents, wherein these can be present in the form of a powder or a finely dispersed pigment preparation in a suitable medium.

Several examples for coating wood-encased pencils are described in the following:

### EXAMPLE 1

| | |
|---|---|
| Mowital B45 H | 75 weight % |
| sucrose acetate isobutyrate (SAIB) | 20 weight % |
| stearic acid | 5 weight % |

Polyvinyl butyral is generally commercially available in different acetalation degrees and molecular-mass distributions. For Example 1, a variant is used that is commercially available under the trade name “Mowital B45 H” by the company Clariant GmbH & Co OHG (Germany). This variant and the variants described below have a softening range of 120 to 180° C. The adhesion promoter used is sucrose acetate isobutyrate (Eastman Chemical Company, U.S.). These substances are mixed together with a wax comprising stearic acid inside a rapid mixer or a kneading machine. The starting materials can also be mixed in an extruder with subsequent granulating. However, the extruded material can also be funneled directly into a heated container.

The containers normally used for the enameling process in the pencil-manufacturing industry have proven to be particularly suitable, wherein additional heating elements for melting the coating material are required. Depending on the type of polymer selected, the temperatures for the relatively low-viscous melt should be between 140° C. and 220° C. The pencils enter front to front into a container, which is sealed on the intake and the discharge side with a felt or rubber stripper. The pencil is pushed through the melted coating mass and is thus coated. Excess coating material is stripped off with the aforementioned stripper when the pencil is discharged from the container. The coating thickness can be adjusted via the contact pressure of the stripper to the desired thickness and ranges between 50 and 200 μm.

Using the above-described technique, a wood-encased pencil with high-gloss and clear coating is obtained.

### EXAMPLE 2

| | |
|---|---|
| Mowital B30 HH | 45-93% |
| ketone formaldehyde resin | 5-30% |
| wax | 1-15% |
| red color pigment | 1-10% |

Mowital B30 HH is another PVB variant produced by the Clariant company.

A ketone formaldehyde resin (for example synthetic resin SK by Degussa-Hüls AG, Germany) is used as the adhesion promoter. The wax is an ethylene-bis-oleamide, for example, which can be obtained under the trade name “Crodamide EBO” and is produced by the company Croda GmbH, Germany. The color pigment used is Renol Rod [Red] FT3ADB-F5R (manufactured by the Clariant Masterbatch GmbH & Co.). The processing of the starting materials and the deposit of the melt occur in accordance with Example 1. A pencil with a red, high-gloss surface is obtained.

### EXAMPLE 3

| | |
|---|---|
| Mowital B30 T | 60% |
| Polyvinyl acetate | 18% |
| talcum | 20% |
| color pigmentation | 2% |

The processing of the PVB variant Mowital B30 T and the other constituents as well as the deposit onto a pencil surface occur in the same way as for the Example 1. The polyvinyl acetate, used in the powdered form, is sold commercially by the Harco Harlow Chemical Co. Ltd., in Great Britain under the trade name “Mowilith 20.” The color pigment added is Ti02 (Tronox A-1, Bayer AG, Germany) and the filler material is talcum (Westmin Talc 8E, MK-Chemicals GmbH, Germany). A pencil having a white, silky-mat surface is obtained.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A material for coating a wood surface, comprising:
a thermoplastic coating material including a polyvinyl butyral polymer.

2. The material according to claim 1, wherein the polyvinyl butyral polymer is a main constituent of the thermoplastic coating material.

3. The material according to claim 2, wherein the thermoplastic coating material includes an adhesion promoter.

4. The material according to claim 3, wherein the adhesion promoter is selected from the group of comsisting of polyacrylates, poly urethanes, polyvinyl acetates, keto aldehyde resins, sucrose derivatives and polyester resins.

5. The material according to claim 3, wherein the thermoplastic coating material comprises 40 to 100 weight % of the polyvinyl butyral polymer, 0 to 60 weight % of the adhesion promoter, and further comprises coloring agents 0 to 10 weight %, filler materials 0 to 50 weight % and additives 0 to 20 weight %.

6. The material according to claim 5, wherein the additives include a wax.

7. The material according to claim 6, wherein the polyvinyl butyral polymer is 50-89% weight %, the wax is 1-10 weight %, and the adhesion promoter is sucrose isobutyrate (SAIB) 10-49 weight %

8. The material according to claim 7, wherein the wax includes stearic acid.

9. The coating material according to claim 6, wherein the polyvinyl butyral polymer is 45-93 by weight %, the adhesion promoter is ketone formaldehyde resin 5-30 weight %, the wax is 1-15 weight % and the color pigment is 1-10 weight %.

10. The coating material according to claim 9, wherein the wax includes ethylene-bis-oleamide.

11. The coating material according to claim 5, wherein the polyvinyl butyral polymer is 50-87 weight %, the adhesion promoter is polyvinyl acetate 5-30 weight %, the filler comprises talcum 5-30%, and the color pigment is 1-15 weight %

12. The coating material according to claim 5, and further including a plasticizer.

13. A method of making a pencil encased in wood, comprising coating the wood casing of the pencil utilizing the material defined in claim 1.
